(19) United States
(12) Patent Application Publication
(10) Pub. No.: US 2011/0146008 A1
(43) Pub. Date: Jun. 23, 2011

(54) MANUAL ACCESS RAMP

(76) Inventor: Eric Hansen, Lake Orion, MI (US)

(21) Appl. No.: 12/973,125

(22) Filed: Dec. 20, 2010

Related U.S. Application Data
(60) Provisional application No. 61/288,629, filed on Dec. 21, 2009.

(51) Int. Cl. A61G 3/06; E01D 1/00; B65G 69/28

(52) U.S. Cl. 14/71.1

(57) ABSTRACT

A manual access ramp including a frame, a platform slidably coupled to the frame, the platform being movable between a stowed position and a deployed position, and a first and second side fences coupled to the platform, the side fences being moveable between a stowed position and an deployed position.

### CROSS-REFERENCE TO RELATED APPLICATIONS

This application claims priority under 35 U.S.C. §119(e) to U.S. Provisional Patent Application No. 61/288,629 filed on Dec. 21, 2009. The content of the application is hereby incorporated by reference in its entirety.

### FIELD OF THE INVENTION

The present invention relates to stowable access ramps, especially for aiding handicapped or elderly persons in the ingress and egress to and from vehicles and the like.

### SUMMARY

In some embodiments, the invention provides an access ramp assembly including a frame assembly and a platform assembly. The platform assembly is movable between a stowed position and a deployed position relative to the frame assembly. The platform assembly includes a platform and a pair of side fences. Each of the side fences is movable between a stowed position and a deployed position, the side fences being substantially perpendicular to the platform in the deployed position. The side fences include integral pull handles having apertures therein.

In other embodiments, the invention provides an access ramp assembly including a frame assembly and a platform assembly. The frame assembly includes a pair of opposed parallel tracks in which side edges of the platform assembly are slidably received. The platform assembly is manually movable between a stowed position and a deployed position relative to the frame assembly by sliding the platform assembly along the tracks. An anti-jam timing assembly couples the frame assembly and the platform assembly. The timing assembly includes a cross shaft and a pair of opposed timing belts. The timing belts are engaged with a corresponding pair of gear wheels provided at opposite ends of the cross shaft.

In yet other embodiments, the invention provides a manual access ramp including a frame having a first track and a second track, the first and second tracks being parallel to each other. The manual access ramp also includes a timing assembly having a cross shaft, a first timing belt and a second timing belt, the first timing belt being coupled to the first track, the second timing belt being coupled to the second track, and the cross shaft being coupled to the first timing belt and the second timing belt. In addition the manual access ramp includes a platform coupled to the first timing belt and the second timing belt, a first end of the platform being moveable along the first track and second track and a first and second side fences coupled to the platform, the side fences being moveable between a stowed position and an deployed position.

Other aspects of the invention will become apparent by consideration of the detailed description and accompanying drawings.

### BRIEF DESCRIPTION OF THE DRAWINGS

FIG. 1 is a perspective view of a manual access ramp assembly including a pair of side fences in the stowed position and showing the pair of side fences in the deployed position in phantom.

FIG. 2 is a detail perspective view of the side fences of the manual access ramp assembly of FIG. 1 showing the side fences in the stowed position.

FIG. 2a is a detail perspective view of the side fences of the manual access ramp assembly of FIG. 1 showing the side fences in the deployed position.

FIG. 3 is a perspective view of an anti-jam timing system of the manual access ramp assembly of FIG. 1.

FIG. 4 is a first detail perspective view of the anti-jam timing system of FIG. 3.

FIG. 5 is a second detail perspective view of the anti-jam timing system of FIG. 3.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

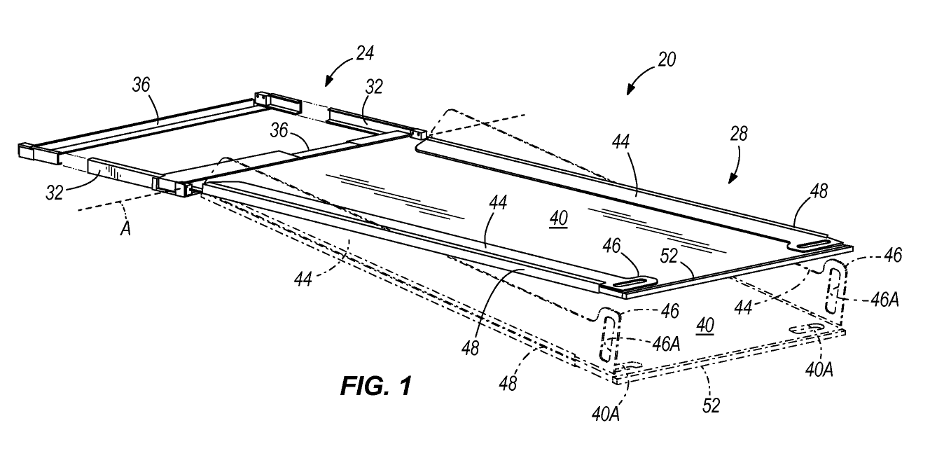

A manual access ramp assembly 20 is illustrated in FIG. 1. The ramp assembly 20 includes a frame assembly 24 and a platform assembly 28. The frame assembly 24 includes a set of parallel left and right tracks 32. A pair of cross members 36 brace the tracks 32 at an inboard end and an outboard end of the frame assembly 24. In an alternative construction a cover is attached to an upper side of the left and right tracks 32 to provide a smooth surface and to inhibit users from tripping on the left and right tracks 32 and the cross members 36.

The frame assembly 24 can be coupled to a structure or vehicle (not shown) so that the platform assembly 28 can be stowed or deployed relative to the structure or vehicle. The platform assembly 28 is selectively lockable in the deployed or stowed position. In one construction, the ramp assembly 20 is provided with a vehicle which may be a van or bus among other types. In such a construction, the frame assembly 24 may be coupled to at least one of a frame and a body of the vehicle at a location directly under the vehicle door to which ramp access is desired to aid entry to and exit from a side door of the vehicle.

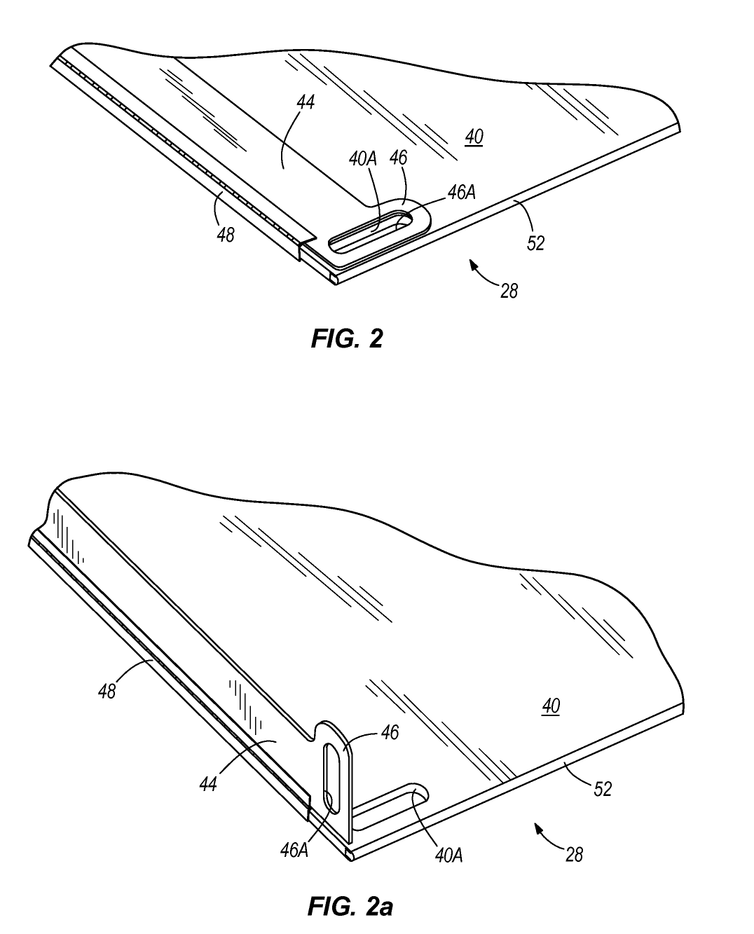

The platform assembly 28 includes a ramp platform 40 and a pair of left and right side fences 44. The side fences 44 are movable between stowed and deployed positions, with the deployed position shown in phantom in FIG. 1. FIG. 2 shows the side fences 44 in the stowed position and FIG. 2a shows the side fences 44 in the deployed position. In the stowed position, each of the side fences 44 lies on the platform 40 so that the platform assembly 28 obtains maximum compactness for stowage. In the deployed position, each of the side fences 44 is at a substantially 90 degree angle with the platform 40. In the deployed position, the side fences 44 keep feet, wheelchair wheels, etc. from slipping off the side edges of the platform 40. The side fences 44 are selectively lockable in the deployed or deployed position.

As shown in FIGS. 1 and 2, each of the side fences 44 is provided with an integrated pull handle 46 at an outboard end thereof. Each pull handle 46 includes an area of enlarged width and an aperture 46A formed therein. In some constructions, each side fence 44 is constructed of a single piece of material formed with the enlarged area and the handle aperture 46A. The platform 40 is provided with apertures 40A corresponding to the apertures 46A of the side fences 44. When the side fences 44 are stowed, lying flat atop the platform 40, the apertures 46A of the side fences 44 lie directly above the apertures 46A, effectively creating one pair of apertures in the platform assembly 28 that can be grasped by the two hands of a user to manipulate the platform assembly 28 when the side fences 44 are stowed. When the side fences 44 are in the deployed position, the integral pull handles 46 provide a convenient location for a user to grasp and manipulate the platform assembly 28. The integral pull handles 46 also provide a convenient location for a user to grasp the side fences 44 during movement of the side fences 44 between the stowed and deployed positions.

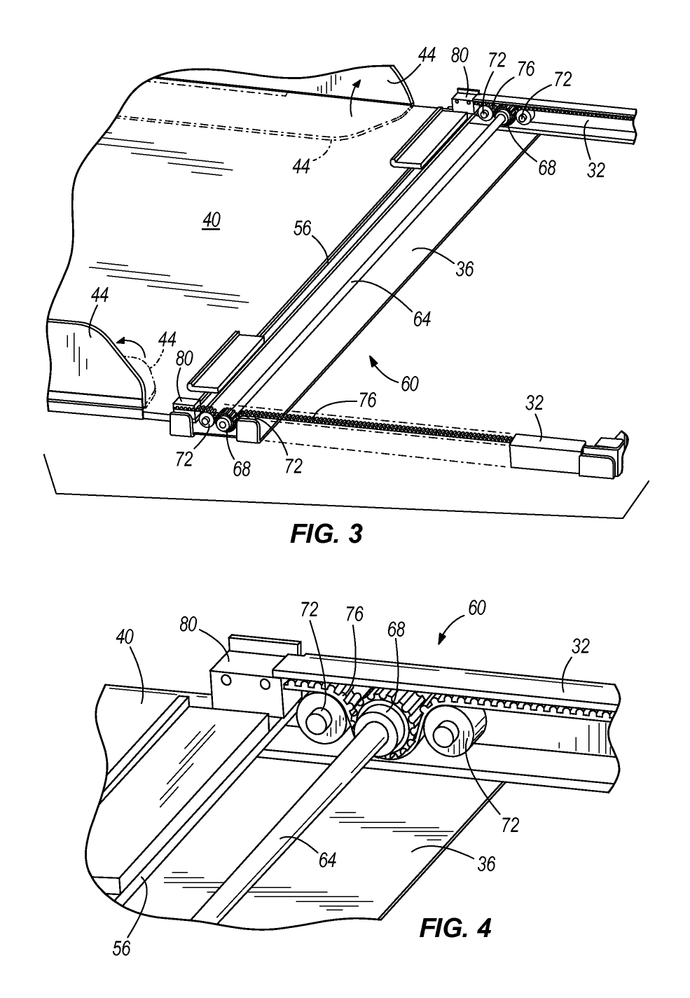

The entire platform assembly 28 is movable between a stowed position (not shown) and a deployed position (FIG. 1). When in the stowed position, left and right side edges 48 of the platform assembly 28 are retained by the tracks 32 of the frame assembly 24. The platform assembly 28 can be pulled substantially straight outward from the tracks 32 until the side edges 48 are free of the tracks 32 (i.e., obtaining the deployed position). Once deployed from the tracks 32, the platform assembly 28 can be rotated relative to the frame assembly 24 and the tracks 32 about a substantially horizontal axis A as shown in FIG. 1. The platform assembly 28 is rotated about the axis A until an outboard edge 52 of the platform 40 contacts a desired surface, which may be at a significantly lower elevation than the elevation of the frame assembly 24. An inboard edge 56 of the platform 40 is supported at the outboard cross member 36 of the frame assembly 24 (FIGS. 3 and 4).

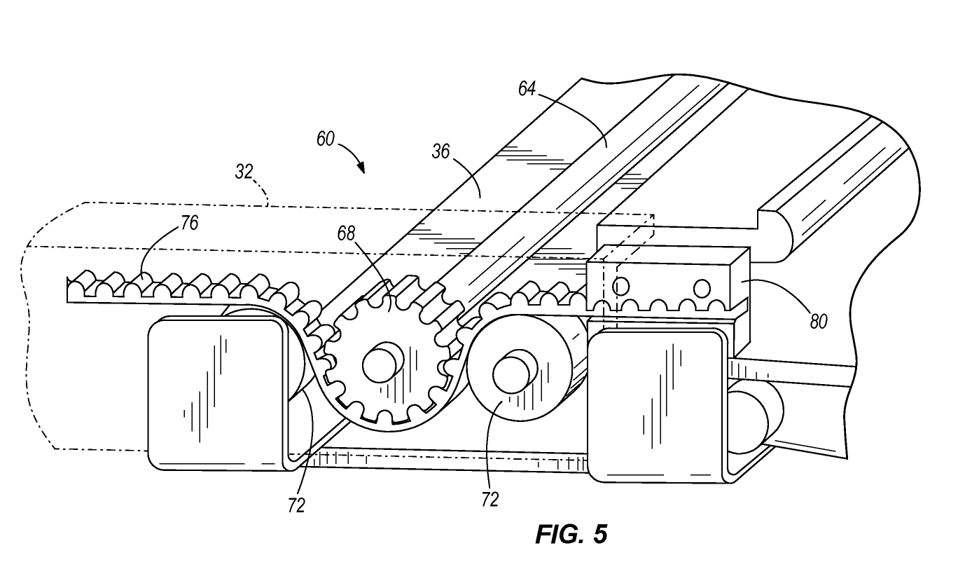

As shown in FIGS. 3-5, an anti-jam timing system 60 couples the frame assembly 24 and the platform assembly 28. The timing system 60 includes a cross shaft 64 that runs between the left and right tracks 32 at an angle substantially perpendicular to the tracks 32. A sprocket or gear wheel 68 is provided on and coupled to each end of the cross shaft 64. A pair of guide wheels 72 are positioned adjacent each of the gear wheels 68. A toothed timing belt 76 is provided on each side of the ramp assembly 20 and serpentines around the corresponding guide wheels 72 and gear wheels 68 such that the teeth of each timing belt 76 engage with the corresponding gear wheel 68. The guide wheels 72 may be toothed or un-toothed. The gear wheel 68, the guide wheels 72, and the timing belt 76 of each side are all housed substantially inside an open interior side of the corresponding one of the tracks 32, which are substantially C-shaped. As best shown in FIG. 4, a clamp 80 is provided adjacent the outboard end of each of the tracks 32 to clamp and hold a free end of the corresponding timing belt 76. The two clamps 80 are each coupled to the platform 40. In one construction the two clamps 80 are coupled to the inboard edge 56 of the platform 40. The two timing belts 76 are provided with substantially identical tooth spacing and the gear wheels 68 are substantially identical in diameter, tooth pitch, etc. so that the two gear wheels 68 rotate the same amount for a given length of timing belt 76 fed therethrough.

As the platform assembly 28 is moved between the stowed and deployed positions (i.e., into and out of the tracks 32), the timing belts 76 on the two sides of the ramp assembly 20 are run through the corresponding gear wheel 68 and guide wheels 72 so that the left and right side edges 48 of the platform assembly 28 are kept in even time with each other. Thus, the platform assembly 28 is maintained substantially parallel with the two tracks 32 and binding, wedging, or jamming of the platform assembly 28 relative to the frame assembly 24 and specifically the tracks 32 is avoided.

In an alternative embodiment an anti-jam timing system includes a non-toothed timing belt and a gear wheel with a substantially smooth circumference. The timing belt and gear wheel are sized and configured to provide a set amount of friction between the timing belt and the gear wheel to assist the left and right side edges 48 of the platform assembly 28 in keeping even time with each other. In yet another alternative embodiment the anti-jam timing system includes a pair of chains which function in a substantially similar fashion to the timing belts 76.

In yet another alternative embodiment each track 32 includes a substantially horizontal slot which runs approximately from one of the cross members 36 to the other cross member 36. The guide wheels 72 are coupled to each track 32 using a bolt, screw, etc. such that the guide wheels 72 are free to move in the track 32 along the horizontal slot between the pair of cross members 36. The bolt, screw, etc. inhibits each guide wheel 72 from being removed from the tracks 32. In yet another embodiment the cross shaft 64 is coupled to each track 32 using a bolt, screw, etc. that passes through the horizontal slot on each track 32.

It should be understood that the embodiments described above and illustrated in the figures are presented by way of example only and are not intended as a limitation upon the concepts and principles of the present invention. As such, it will be appreciated by one having ordinary skill in the art that various changes are possible.

What is claimed is:

1. A manual access ramp comprising:
a frame;
a platform slidably coupled to the frame the platform being movable between a stowed position and a deployed position; and
first and second side fences coupled to the platform, each of the first and second side fences being moveable between a stowed position and an deployed position.

2. The manual access ramp of claim 1 wherein the first and second side fences are substantially perpendicular to the platform when the first and second side fences are in the deployed position.

3. The manual access ramp of claim 2 wherein the first and second side fences lay substantially flat against the platform when the first and second side fences are in the stowed position.

4. The manual access ramp of claim 1 wherein the first and second side fences include integral pull handles having apertures therein.

5. The manual access ramp of claim 4 wherein the platform includes integral pull handles having apertures therein.

6. The manual access ramp of claim 5 wherein the integral pull handles of the first and second side fences lay substantially atop the integral pull handles of the platform when the first and second side fences are in the stowed position.

7. The manual access ramp of claim 1 further comprising a locking mechanism to lock at least one of the first and second side fences in the deployed position.

8. The manual access ramp of claim 7 further comprising a locking mechanism to lock the platform in at least one of the stowed and deployed positions.

9. The manual access ramp of claim 1 further comprising a cover coupled to the frame which substantially covers the platform when the platform is in the stowed position.

10. A manual access ramp comprising:
a frame having a first track and a second track, the first and second tracks being parallel to each other;
a timing assembly having a cross shaft, a first timing belt, and a second timing belt, the first timing belt being coupled to the first track, the second timing belt being coupled to the second track, and the cross shaft being coupled to the first timing belt and the second timing belt; and
a platform coupled to the first timing belt and the second timing belt, a first end of the platform being moveable along the first track and second track.

11. The manual access ramp of claim 10 further comprising:
a first gear wheel coupled to the cross shaft and the first timing belt; and
a second gear wheel coupled to the cross shaft and the second timing belt.

12. The manual access ramp of claim 10 further comprising a plurality of guide wheels disposed in the first track and the second track.

13. The manual access ramp of claim 12 wherein at least one of the first track and the second track include a substantially horizontal slot and the guide wheels are slidably coupled to at least one of the first track and the second track.

14. The manual access ramp of claim 10 wherein at least one of the first timing belt and the second timing belt is a chain.

15. The manual access ramp of claim 10 wherein at least one of the first timing belt and the second timing belt is toothed.

16. The manual access ramp of claim 10 wherein at least one of the first track and the second track include a substantially horizontal slot and the cross shaft is slidably coupled to at least one of the first track and the second track.

17. The manual access ramp of claim 10 further comprising a cover coupled to the frame, the cover substantially covering the timing assembly.

18. A manual access ramp comprising:
a frame having a first track and a second track, the first and second tracks being parallel to each other;
a timing assembly having a cross shaft, a first timing belt and a second timing belt, the first timing belt being coupled to the first track, the second timing belt being coupled to the second track, and the cross shaft being coupled to the first timing belt and the second timing belt;
a platform coupled to the first timing belt and the second timing belt, a first end of the platform being moveable along the first track and second track; and
first and second side fences coupled to the platform, the side fences being moveable between a stowed position and an deployed position.

19. The manual access ramp of claim 18 wherein the first and second side fences include integral pull handles having apertures therein.

20. The manual access ramp of claim 19 wherein the platform includes integral pull handles having apertures therein.

21. The manual access ramp of claim 20 wherein the integral pull handles of the first and second side fences lay substantially atop the integral pull handles of the platform when the first and second side fences are in the stowed position.

22. The manual access ramp of claim 21 further comprising a cover coupled to the frame, the cover substantially covering the timing assembly.

23. The manual access ramp of claim 22 further comprising:
a first gear wheel coupled to the cross shaft and the first timing belt; and
a second gear wheel coupled to the cross shaft and the second timing belt.

24. The manual access ramp of claim 23 further comprising a plurality of guide wheels disposed in the first track and the second track.

25. The manual access ramp of claim 24 wherein at least one of the first track and the second track include a substantially horizontal slot and the guide wheels are slidably coupled to at least one of the first track and the second track.

26. The manual access ramp of claim 25 wherein the cross shaft is slidably coupled to at least one of the first track and the second track.

27. The manual access ramp of claim 18 wherein at least one of the first timing belt and the second timing belt is a chain.

28. The manual access ramp of claim 18 wherein at least one of the first timing belt and the second timing belt is toothed.

29. The manual access ramp of claim 18 further comprising a locking mechanism to lock the platform in at least one of the stowed and deployed positions.

30. The manual access ramp of claim 18 further comprising a locking mechanism to lock at least one of the first and second side fences in the deployed position.
